(19) United States
(12) Patent Application Publication
(10) Pub. No.: US 2006/0097482 A1
(43) Pub. Date: May 11, 2006

(54) ATV trailer apparatus

(76) Inventor: Bobby Cumbie, Newnan, GA (US)

Correspondence Address: GEORGE R. REARDON, 3356 STATION COURT, LAWRENCVILLE, GA, 30044, US

(21) Appl. No.: 10/983,843

(22) Filed: Nov. 8, 2004

(51) Int. Cl. B60D 1/54

(52) U.S. Cl. 280/491.3

(57) ABSTRACT

An ATV trailer is described, including a wheeled frame portion having a multi-purpose tongue secured thereto which extends forwardly for connection to an all-terrain vehicle (ATV). In the various embodiments of the ATV trailer, the multi-purpose tongue may be enabled for pivoting to a near vertical position for storage, enabled for better tracking over rough terrain, and the like. The wheel assembly may pivot or be fixed, depending on the embodiment of the ATV trailer. The ATV trailer includes an adjustable mud flap assembly.

### BACKGROUND OF THE INVENTION

The present invention relates generally to a trailer apparatus and more particularly to an All Terrain Vehicle (ATV) utility trailer apparatus with extended versatility having transformation capability for animal transport and lawn and garden supplies, tools and equipment transport.

Traditionally, there have been various types of utility trailers have been developed for use with ATVs depending on the task to be performed. ATV trailers must be capable of successfully traversing a wide range of terrain, especially un-cleared land. ATV trailers are generally no wider than the towing ATV and must be tough enough to take substantial abuse while carrying considerable loads of non-uniform size and weight over a variety of terrains.

ATVs are commonly used for hunting and specialty trailers have been designed for removing large game from the field and returning to the camp. These trailers may not be useful in transporting a wide variety of things that may be necessary around a farm when not being used for hunting purposes. Therefore, a more versatile trailer is needed that is capable of being used as both a diversified utility work trailer and a game transport trailer, thereby making the trailer more economical.

Previous attempts to provide for deer transport behind an ATV include U.S. Pat. No. 5,645,292, issued to McWilliams, which teaches a two wheeled trailer to be towed behind all terrain vehicle—has upright brace, includes upper and lower ends extending between each axle assembly end portion, and upper portion of corresponding trailer side. Previous attempts to provide for a more versatile ATV trailer include U.S. Pat. No. 6,557,882, issued to Harrington, which teaches an ATV) utility trailer used in hunting which has a tongue portion extended forwardly and axial and wheel assembly fixed to enclosed compartment located perpendicular to transverse walkway. Previous attempts to provide an ATV trailer that folds vertical behind the ATV include U.S. Pat. No. 6,254,117, issued to Cross which teaches a folding trailer that pivots and is secured to the ATV rack.

While these patents and other previous methods have attempted to solve the problem of loading and transporting animals and materials, none have employed tool holders, attachments for additional towing, adjustable mud flaps, or an adjustable hitching device.

Therefore, a need exists for an improved, versatile ATV trailer that has increased utility in the field, farm and at home.

The foregoing patent and other information reflect the state of the art of which the inventor is aware and are tendered with a view toward discharging the inventor's acknowledged duty of candor in disclosing information that may be pertinent to the patentability of the present invention. It is respectfully stipulated, however, that the foregoing patent and other information do not teach or render obvious, singly or when considered in combination, the inventor's claimed invention.

### BRIEF SUMMARY OF THE INVENTION

The general purpose of the present invention, which will be described subsequently in greater detail, is to provide a new ATV trailer with increased versatility and utility in a variety of situations and environments. The present invention is intended to be used behind an ATV or similar method of transport.

One objective of the present invention is to provide a device that can be towed behind an ATV.

Another objective of the present invention is to provide a device that can be used behind an ATV that is cost effective.

Another objective of the present invention is to provide a device that can be used behind an ATV that is easy to use.

Another objective of the present invention is to provide a device that can be used behind an ATV that can be reused many times.

Another objective of the present invention is to provide a device that can be used behind an ATV that is enabled for convenient storage.

Another objective of the present invention is to provide an assembly process for making the invention which uses readily available materials and components.

Another objective of the present invention is to provide a method for using the invention that is easy to learn.

Additional objects and advantages of the invention will be set forth in part in the description which follows, and in part will be obvious from the description, or may be learned by practice of the invention. The objects and advantages of the invention will be obtained by means of instrumentalities in combinations particularly pointed out in the appended claims.

The basis for the present invention is centered on a trailer frame enabled for towing behind an ATV.

The disclosed trailer apparatus is an improved utility trailer for all terrain vehicles. The trailer includes features which allow the trailer to be used for a variety of tasks commonly associated with ATVs around homes, farms, camps, etc. such as hauling firewood, feed, hay, fertilizer, seed, and chemicals, while improvements to the trailer further include, among others, being low to the ground, mud deflectors to prevent mud from getting on the killed game during transport over muddy terrain, a variety of wheel assemblies to facilitate transport based on user preference and terrain, attachments for tool transport, spraying devices and spreader devices, an adjustable, telescoping tongue, the ability to rotate the trailer to a roughly vertical position behind the ATV.

The present invention is comprised of a frame, wheels, front hitching means that is adjustable and versatile and mud flaps that are adjustable. Some embodiments of the invention are further comprised of tool attachments and rear hitching means. Likewise some embodiments of the invention utilize fixed wheel assemblies, while other embodiments of the invention utilize rotatable wheel assemblies. Additionally, some embodiments of the invention utilize telescoping front hitching means that is rotatable to a roughly vertical position, while other embodiments of the invention utilize telescoping front hitching means with a ball joint that is not rotatable to a roughly vertical position, but which allows for better tracking of the cart with the ATV.

The present invention is designed to be multifunctional. For example, a hunter is able to load a deer or any game animal by himself and transport the deer out of the woods without throwing mud all over the deer or other cargo. Additionally the hunter can also telescope the invention back away from the muffler on the ATV, which also protects cargo being hauled. The invention is designed to go anywhere an ATV can go without causing erosion to the land when going over ditches & terraces. When not in use some embodiments of the invention can be folded up out of the way. In some embodiments of the invention there is a simple permanent mount spring-loaded pin which serves three separate functions: one to telescope the cart in, one to telescope out and one to lock the invention in an upright position.

Similarly, in some embodiments of the invention, the homeowner is able to use the invention at times when most ATVs are sitting idle. These embodiments of the invention can be used in the yard, vegetable and flower gardens to carry necessary tools, fertilizer, seed, flowers shrubs, buckets, chain saws, gas cans, garden hose and other accessories. Tools can be placed in an upright position without having to strap each individual tool down. Additionally these embodiments of the invention can be used to seed and fertilize a lawn or pasture in conjunction with a fertilizer/seed spreader. These embodiments of the invention enable the hauling of extra bags of seed and fertilizer to refill the spreader without returning to house or barn. The user can control the opening and closing of the spreader from the seat of the ATV with a lever. Additionally these embodiments of the invention can be used to hold a chemical sprayer instead of having the chemical sprayer strapped to the rack of the ATV. The hose holder in this embodiment of the invention keeps the hose away from ATVs rear tires while operating sprayer from seat of ATV.

The farmer and rancher can telescope the invention out to haul hay and to feed the livestock. Additionally, the invention can be used to carry posthole diggers, wire, chain saws, axes and other necessary equipment used to make fence repairs. The invention is enabled to be towed by an ATV to terrain that might be unable to reach by other means of transportation.

Cable, telephone and power contractors, as well as landscapers, can carry tools and equipment necessary for installation and repairs on right-of-ways or any area that has a limited access.

There has thus been outlined, rather broadly, the more important features and benefits of the invention in order that the detailed description thereof that follows may be better understood, and in order that the present contribution to the art may be better appreciated. There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE SEVERAL VIEWS OF THE DRAWING

The accompanying drawings illustrate a complete embodiment of the invention according to the best modes so far devised for the practical application of the principles thereof, and in which:

FIG. 1 is a perspective view of one embodiment of the invention.

FIG. 2 is a perspective view of one embodiment of the invention.

FIG. 3 is a side view of one embodiment of the invention.

FIG. 4 is a bottom view of one embodiment of the invention.

FIG. 5 is a back perspective view of one embodiment of the invention.

FIG. 6 is a side view of one embodiment of the invention.

FIG. 7 is a perspective view of one embodiment of the invention.

FIG. 8 is a perspective view of one embodiment of the invention.

FIG. 9 is a perspective view of one embodiment of the invention.

FIG. 10 is a perspective view of one embodiment of the invention.

FIG. 11 is a perspective view of one embodiment of the invention.

FIG. 12 is a perspective view of one embodiment of the invention.

FIG. 13 is a front perspective view of one embodiment of the invention.

FIG. 14 is an exploded view of one embodiment of the invention.

FIG. 15 is a bottom view of one embodiment of the invention.

FIG. 16 is a bottom view of one embodiment of the invention.

FIG. 17 is a back view of one embodiment of the invention.

FIG. 18 is a front view of one embodiment of the invention.

FIG. 19 is a right side view of one embodiment of the invention.

FIG. 20 is a left side view of one embodiment of the invention.

FIG. 21 is a view of the mud flap assembly portion of one embodiment of the invention.

FIG. 22 is a view of the tool holder assembly portion of one embodiment of the invention.

FIG. 23 is a top view of the tool holder assembly portion of one embodiment of the invention.

FIG. 24 is a front view of the tool holder assembly portion of one embodiment of the invention.

FIG. 25 is a front view of the hose holder assembly of one embodiment of the invention.

FIG. 26 is a back view of the hose holder assembly of one embodiment of the invention.

FIG. 27 is a top view of the hose holder assembly of one embodiment of the invention.

FIG. 28 is a side view of the spreader attachment of one embodiment of the invention.

FIG. 29 is a side view of the spreader attachment of one embodiment of the invention.

FIG. 30 is a top view of the hitch assembly portion of one embodiment of the invention, in extended position.

FIG. 31 is a top view of the hitch assembly portion of one embodiment of the invention, in retracted position.

FIG. 32 shows the major parts of one embodiment of the invention.

FIG. 33 shows the left side view of one embodiment of the invention.

FIG. 34 shows a right side view of one embodiment of the telescoping hitching means.

FIG. 35 shows a top view of one embodiment of the tongue assembly.

FIG. 36 shows a top view of one embodiment of the tongue assembly retracted.

FIG. 37 shows a top view of one embodiment of the tongue assembly extended.

FIG. 38 shows a bottom view of one embodiment of the tongue assembly retracted.

FIG. 39 shows a bottom view of one embodiment of the tongue assembly extended.

FIG. 40 shows detail of a top view of one embodiment of the tongue assembly using a ball joint.

FIG. 41 shows detail of a left side view of one embodiment of the tongue assembly using a ball joint.

FIG. 42 shows a rear view of one embodiment of the wheel assembly using fixed wheels.

FIG. 43 shows detail of a left side view of one embodiment of the wheel assembly using fixed wheels.

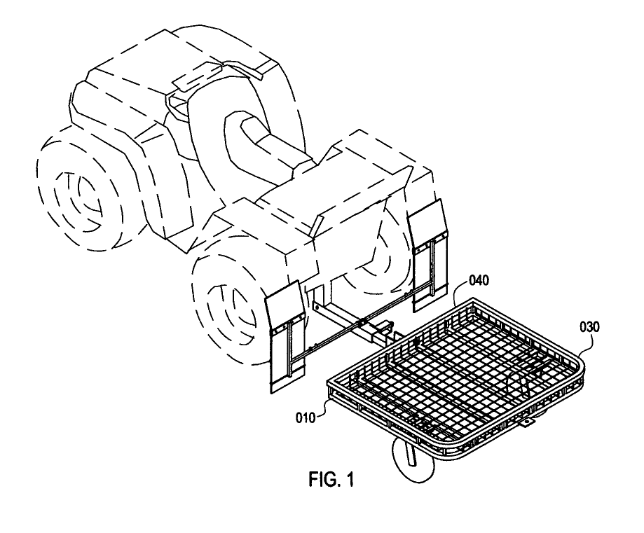

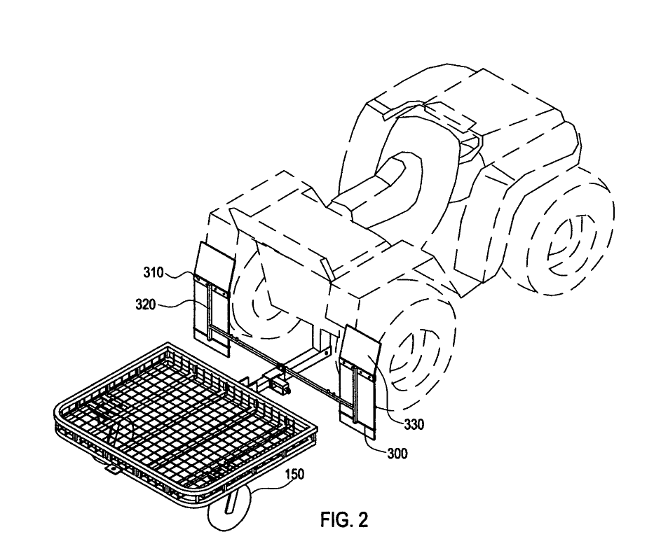

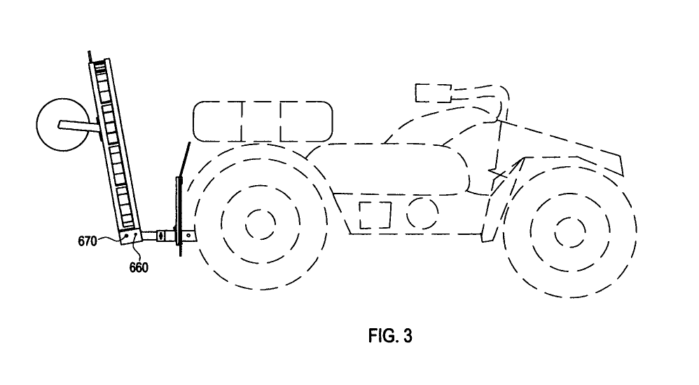

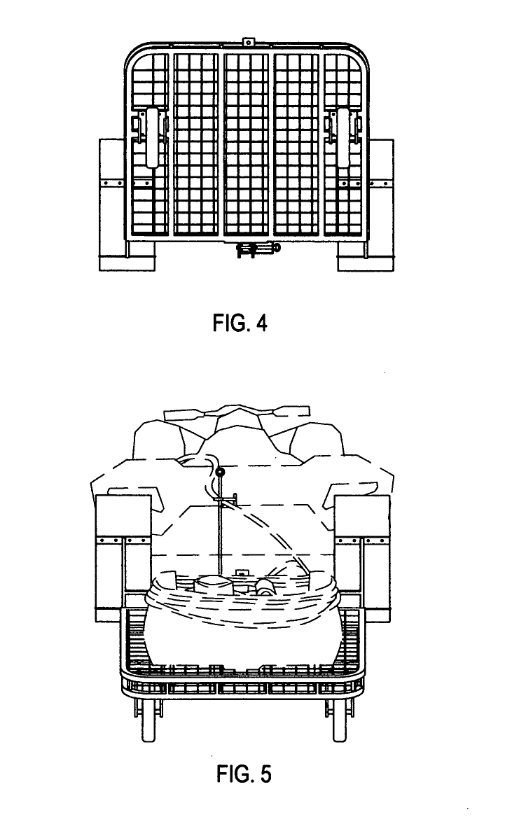

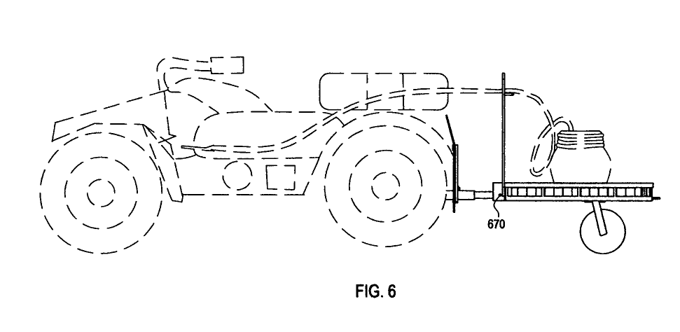

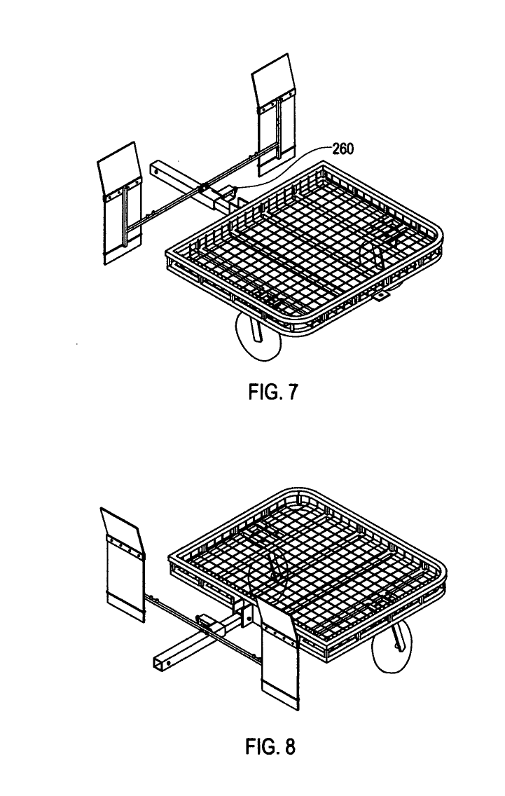

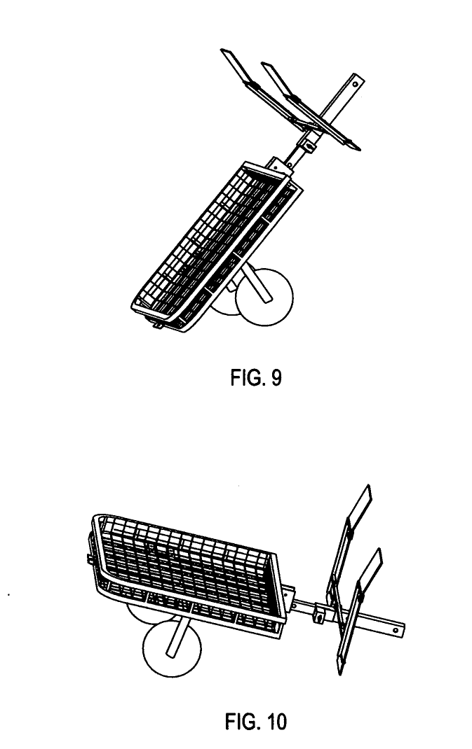

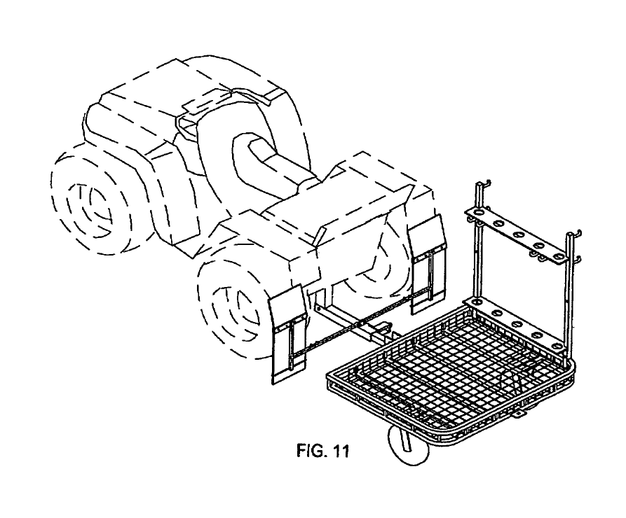

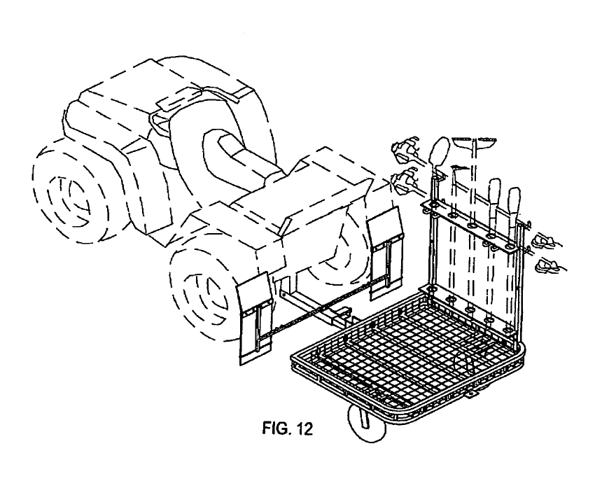

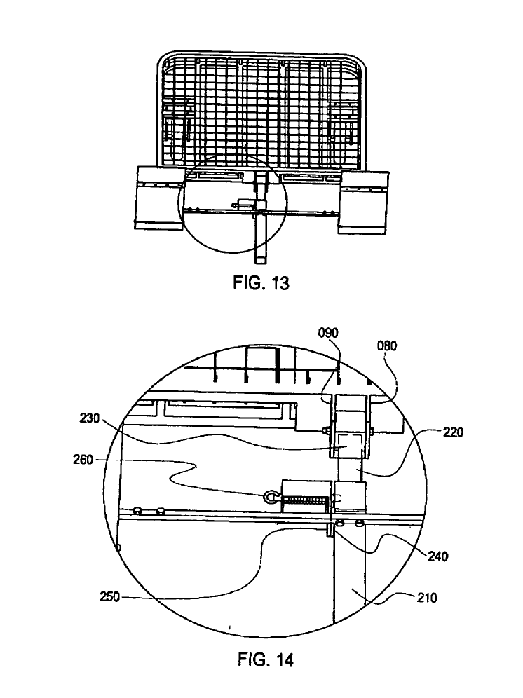

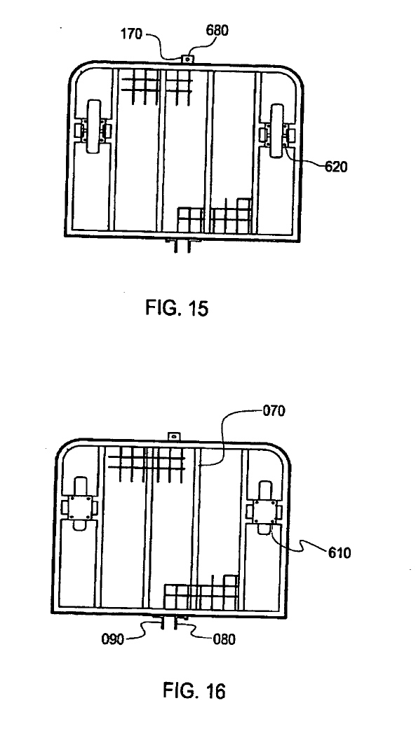

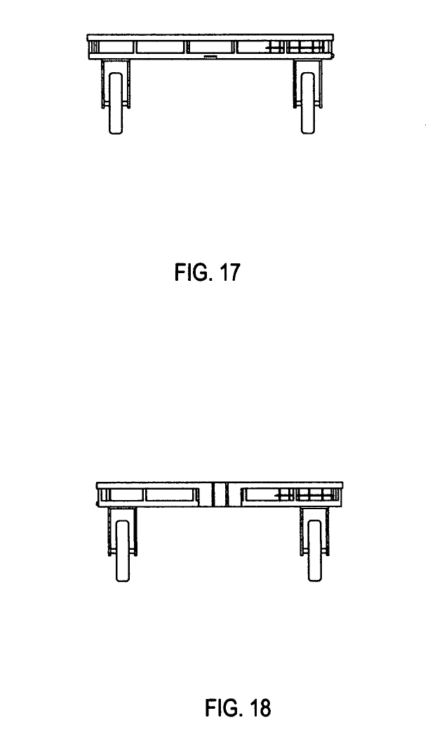

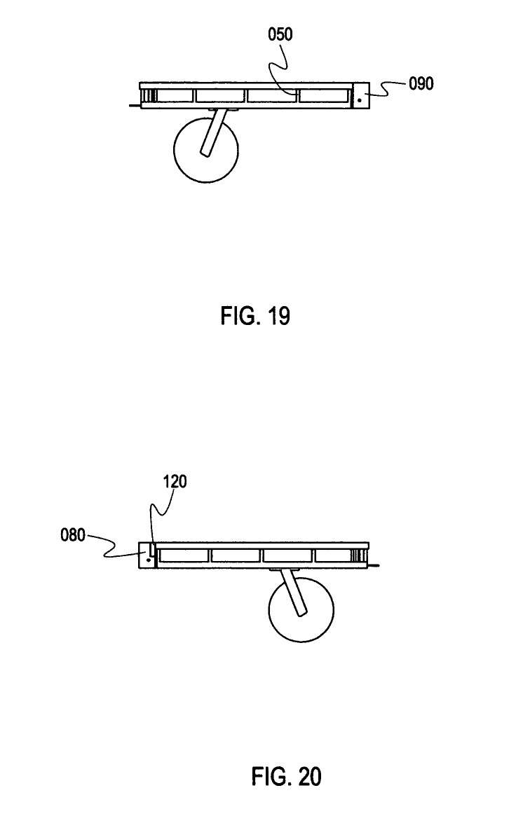

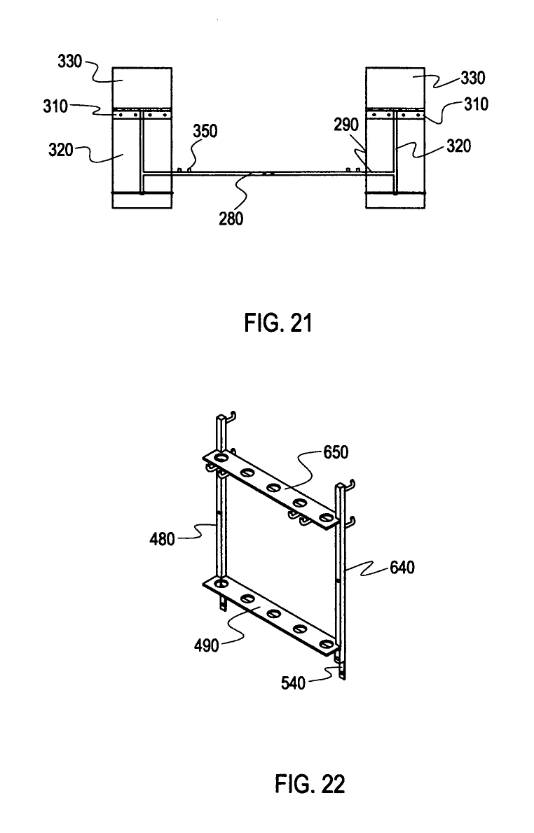

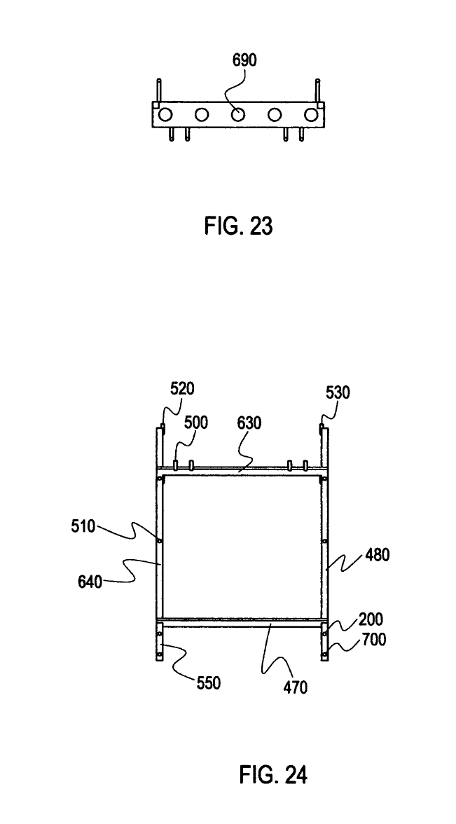

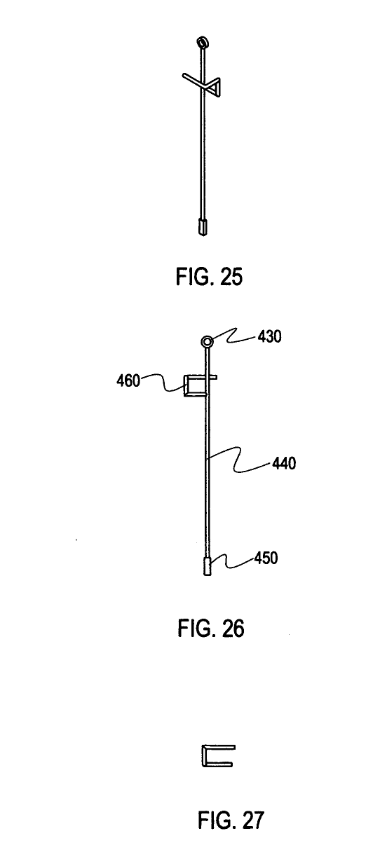

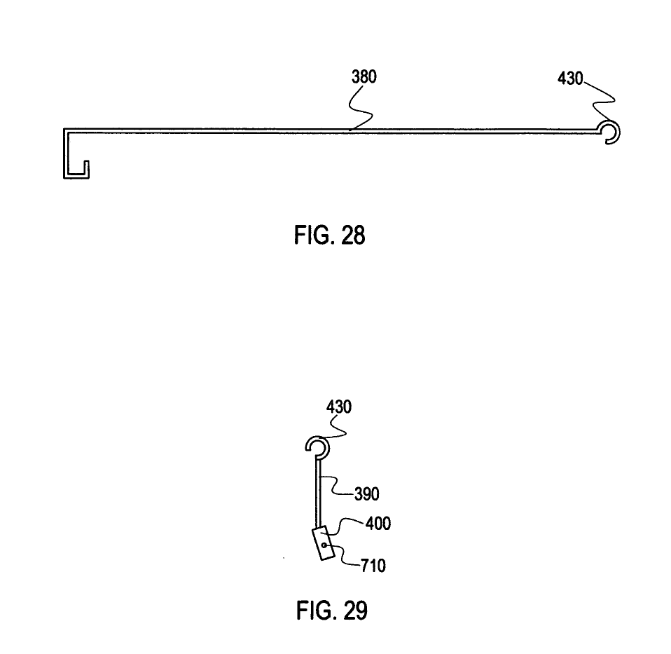

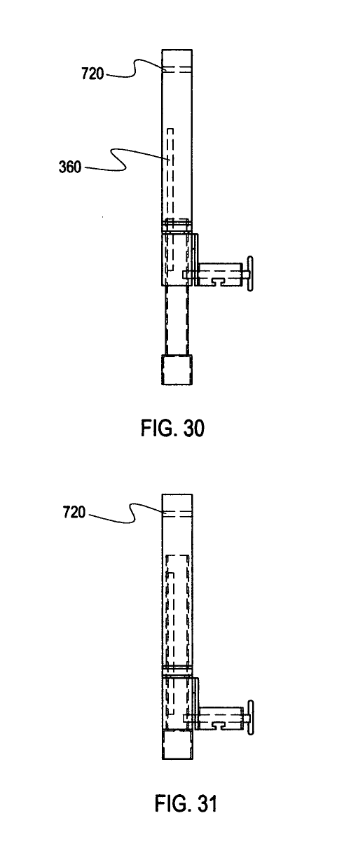

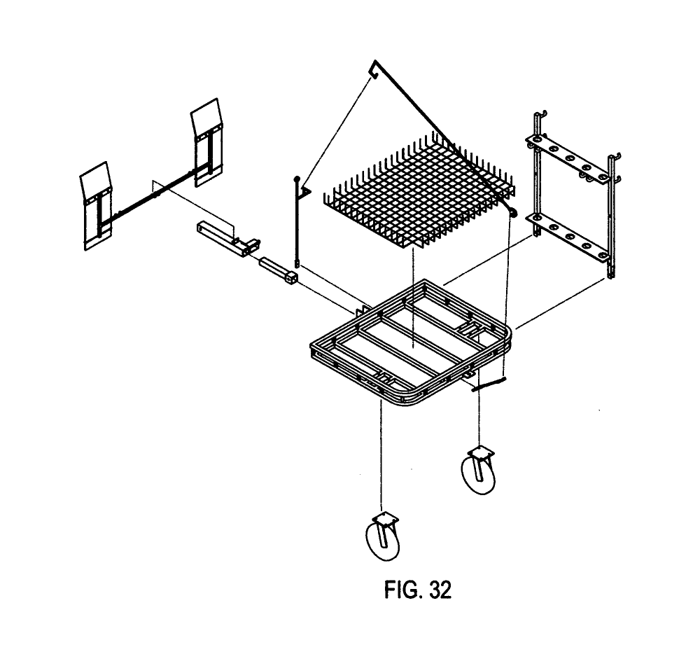

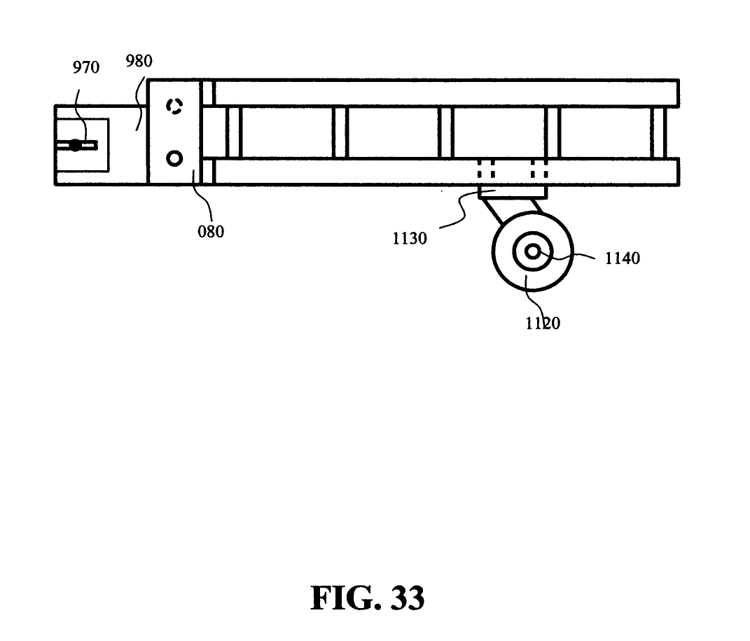

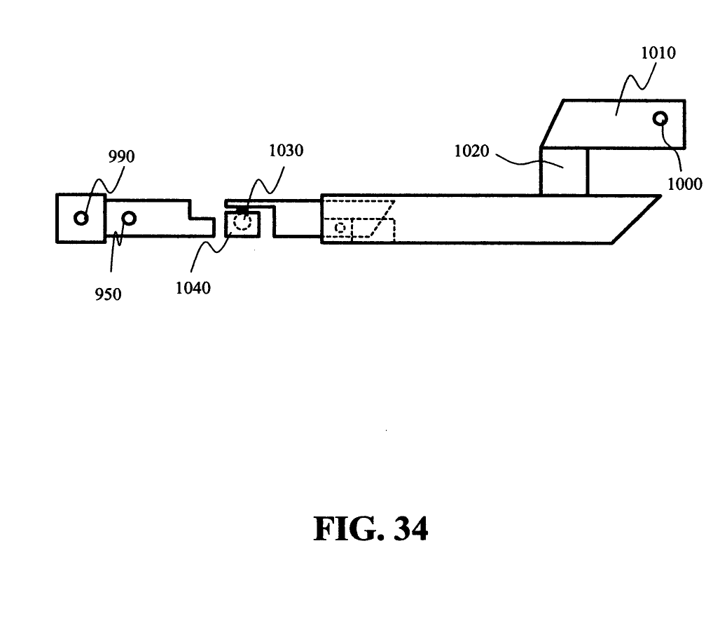

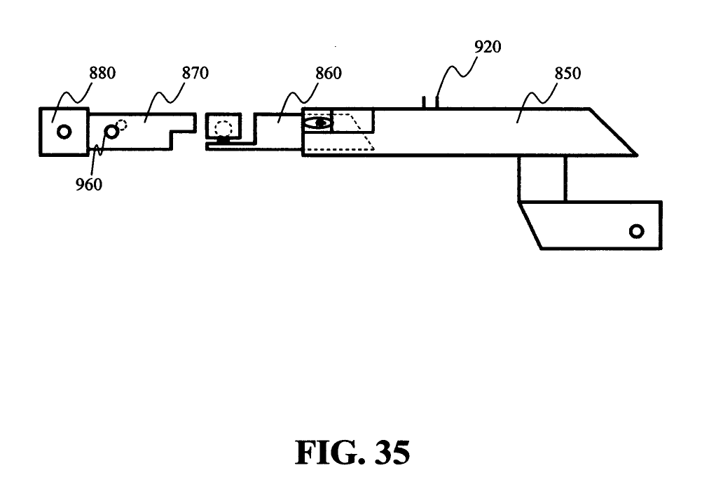

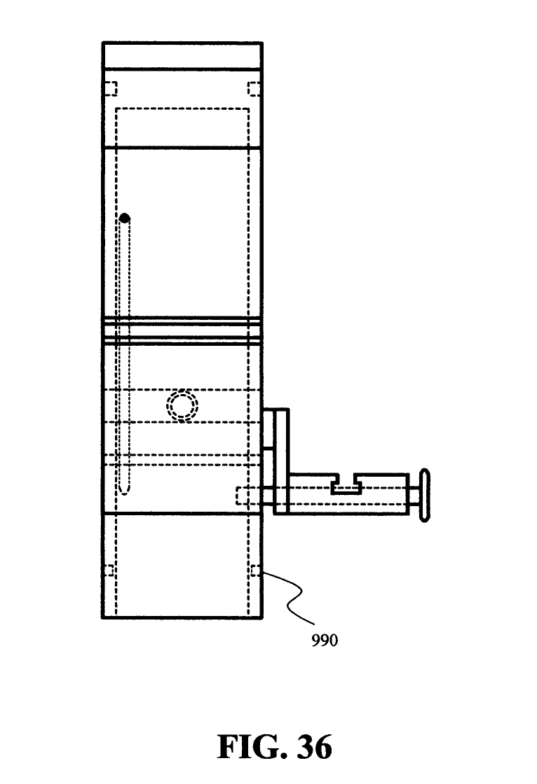

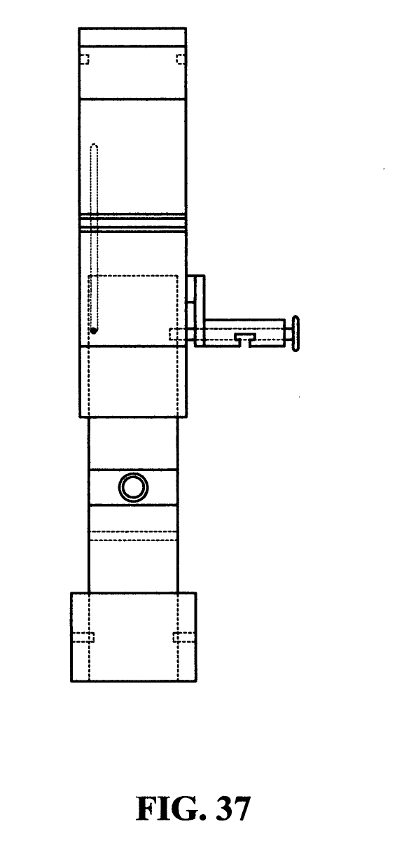

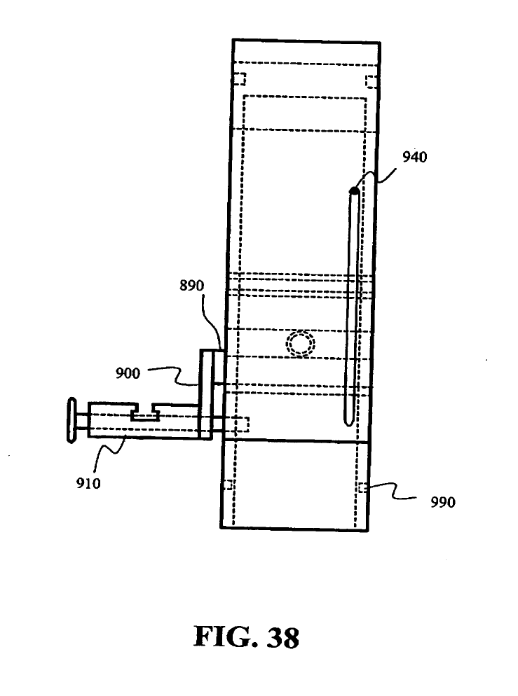

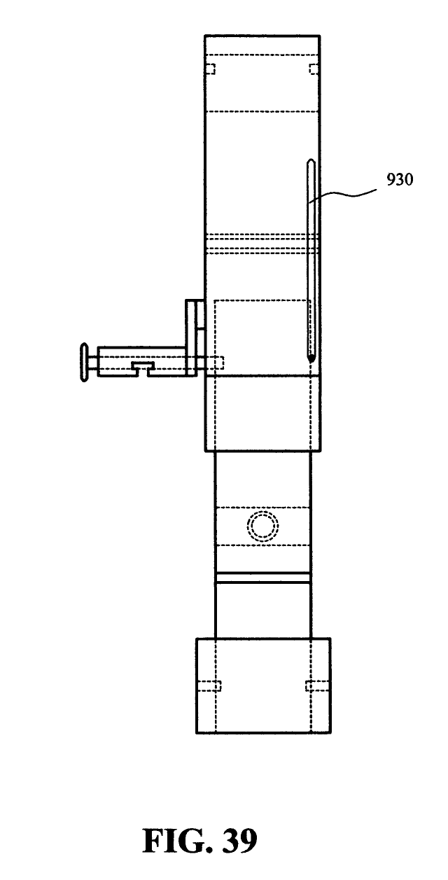

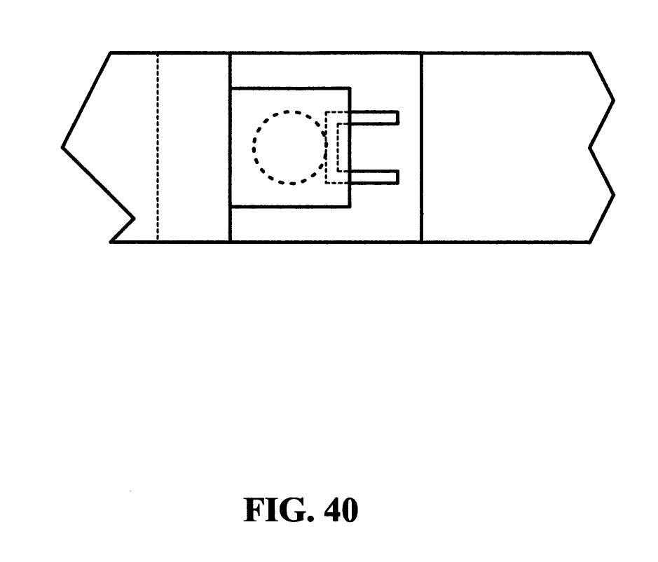

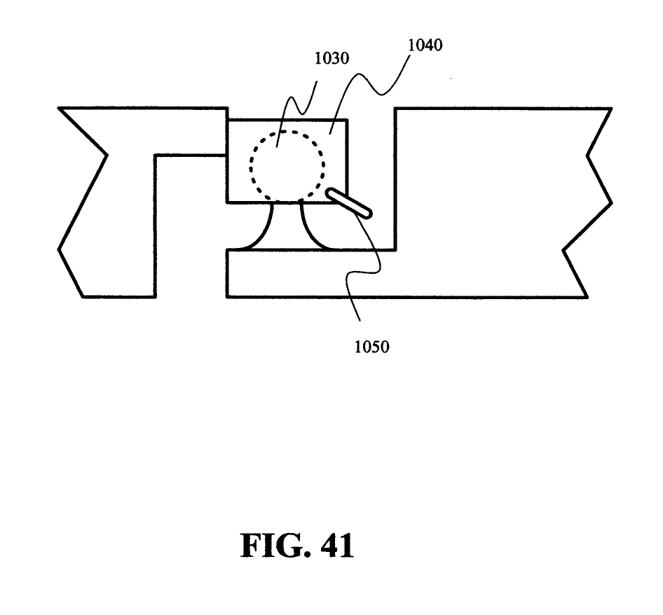

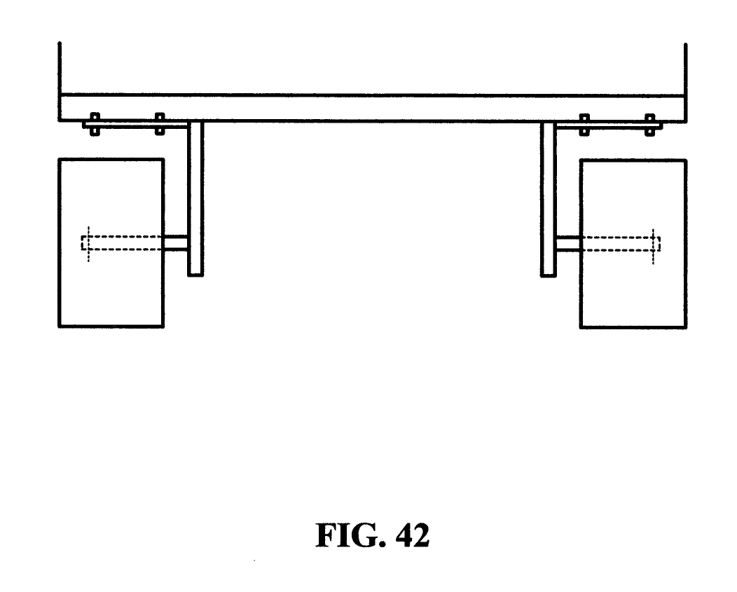

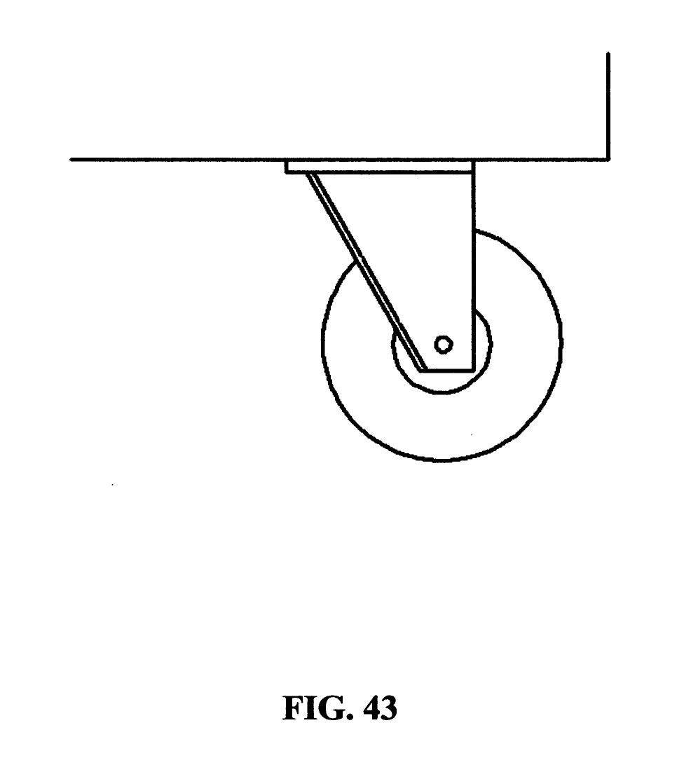

### DETAILED DESCRIPTION OF THE INVENTION

Before explaining the disclosed embodiment of the present invention in detail it is to be understood that the invention is not limited in its application to the details of the particular arrangement shown since the invention is capable of other embodiments. Also, the terminology used herein is for the purpose of description and not of limitation.

The preferred embodiment of the invention is centered on a selectively foldable ATV utility trailer comprising:
1) a frame portion having a forward end, a rearward end, opposite sides, an upper end, flooring, and a lower end, wherein said lower end is offset from said upper end;
2) a first wheel assembly and a second wheel assembly, securely attached to the bottom of said first frame portion, wherein said first wheel assembly and said second wheel assembly have 360° horizontal pivotal means that allows the selectively foldable ATV utility trailer to maneuver inline with the ATV (tracks with the ATV for both forward and reverse directions);
3) a slidably adjustable, elongated tongue member, having ATV securing means, wherein said tongue member has pivotal securing means about a vertical axis transverse to the longitudinal axis of said tongue member wherein said frame portion is selectively in ground-engagement to a substantially vertically disposed position rearwardly of the ATV; and
4) a rear trailer hitch attaching means.
5) The invention is further comprised of an adjustable mud flap assembly, a releasably attached tool holder assembly and a releasably attached spreader assembly.

The preferred embodiment of the invention is made as follows:
1) Weld the Bottom Front Frame, 020, to the Bottom Frame, 010.
2) Weld the Front Top Rail, 040, to the Top Rail, 030.
3) Weld the Post, 050, to the welded combination of the Top Rail, 030, and the Front Top Rail, 040.
4) Weld the Post, 050, to the welded combination of the Bottom Frame, 010, to the Bottom Front Frame, 020.
5) Weld the Flooring with the Four Side Inserts, 060, to the welded combination of the Top Rail, 030, the Front Top Rail, 040 and welded combination of the Bottom Frame, 010 and the Bottom Front Frame 020.
6) Weld the Cross Members, 070, to welded combination of the Bottom Frame, 010, and the Bottom Front Frame, 020.
7) Weld the Front Frame Spacer, 110, to the Bottom Front Frame, 020.
8) Weld the Right Tongue Bracket, 090, to the Front Top Rail, 040, and the Right Front Frame Spacer, 110A.
9) Weld the Left Tongue Bracket, 080, to the Front Top Rail, 040, and the Left Front Frame Spacer, 110B.
10) Weld the Fertilizer Spreader Lever/Chemical Hose Holder Bracket, 120, to the Left Tongue Bracket, 080.
11) Weld the Thumb Screw Nut, 130, to the Fertilizer Spreader Lever/Chemical Hose Holder Bracket, 120.
12) Attach the Thumb Screw, 140, to the Thumb Screw Nut, 130, by threading.
13) Weld the Wheel Mounting Bracket, 160, to the Cross Members, 070, and the Bottom Frame, 010.
14) Attach the Wheel Assembly, 150, to the Wheel Mounting Bracket, 160, using the Bolt, 610, and the Lock Nut, 620 by threading.
15) Weld the Rear Trailer Hitch, 170, to the Bottom Frame, 010.
16) Weld a Tool Holder Mounting Nut, 180, to the front right side of the Frame, 010.
17) Weld a Tool Holder Mounting Nut, 180, to the rear right side of the Frame, 010.
18) Slide the Internal Tongue, 220 inside the External Tongue, 210, and keep in place by the Pin, 370, and weld to the Internal Tongue, 220.
19) The Pin, 370, travels in the Slot, 360.
20) Slide the Internal Tongue, 220 inside the Collar, 230 and weld.
21) Install the Internal Tongue, 220, and the Collar, 230, into the Left Tongue Bracket, 080, and the Right Tongue Bracket, 090, using the Bolt, 560, the Lock Washer, 580 and the Nut, 570.
22) Weld the Spring Lock Bracket Spacer, 240, to the External Tongue, 210.
23) Weld the Spring Lock Mounting Plate, 250 to the Spring Lock Bracket Spacer, 240.
24) Weld the Spring Locking Pin, 260, to the Spring Lock Mounting Plate, 250.
25) Weld the Mud Flap Bracket, 270 to the External Tongue, 210.
26) Attach the Mud Flap Frame, 280, to the Mud Flap Bracket, 270 using the Bolt, 590, and the Lock Nut, 600 by threading.
27) Weld the Set Screw Holder, 340, to the Mud Flap Frame, 280.
28) Attach the Set Screw, 350, to the Set Screw Holder, 340, by threading.
29) Attach the Mud Flap Adjusting Rod, 290, to the Mud Flap Frame, 280 using the Set Screw, 350.
30) Weld the Vertical Mud Flap Brace, 320 to the Mud Flap Adjusting Rod, 290.
31) Weld the Mud Flap Guide, 300, to the Vertical Mud Flap Brace, 320.
32) Weld the Mud Flap Top Mounting Bracket, 310, to the Vertical Mud Flap Brace, 320.
33) Attach the Mud Flap, 330, to the Mud Flap Top Mounting Bracket, 310, using the Mud Flap Retaining Bolt, 790, and the Mud Flap Retaining Nut, 800.
34) Weld the Horizontal Fertilizer Spreader Lever, 380, to the Eye Bolt, 430.
35) Weld the Vertical Fertilizer Spreader Lever, 390, to the Eye Bolt, 430.
36) Attach the Vertical Fertilizer Spreader Lever, 390, to the Horizontal Fertilizer Spreader Lever, 380 using the Eye Bolt, 430.
37) Weld the Vertical Fertilizer Spreader Lever, 390, to the Fertilizer Spreader Handle Connector, 400.
38) Weld the Set Screw Holder, 410, to the Fertilizer Spreader handle Connector, 400.
39) Attach the Thumb Screw, 420, to the Set Screw Holder, 410, by threading.
40) Attach the Fertilizer Spreader Lever/Chemical Hose Holder, 450, to the Fertilizer Spreader Lever/Chemical Hose Holder, 440, by welding.
41) Insert the Fertilizer Spreader Lever/Chemical Hose Holder, 450, into the Fertilizer Spreader Lever/Chemical Hose Holder Bracket, 120.
42) Attach the Thumb Screw, 140, to the Thumb Screw Nut, 130, by threading.
43) Weld the Fertilizer Spreader Lever/Chemical Hose Holder, 440, to the Fertilizer Spreader Lever/Chemical Hose Insert, 450.
44) Weld the Hose Holder, 460, to the Fertilizer Spreader Lever/Chemical Hose Holder, 440.
45) Weld the Eye Bolt, 430 to the Fertilizer Spreader Lever/Chemical Hose Holder, 440.
46) Weld the Tool Holder Horizontal Frame, 470, to the Tool Holder Vertical Frame, 480, and the Tool Holder Rear Vertical Frame, 640.
47) Weld the Tool Holder Top Horizontal Frame, 630, to the Tool Holder Vertical Frame, 480, and the Tool Holder Rear Vertical Frame, 640.
48) Weld the Tool Holder Bottom Bracket, 490, to the Tool Holder Horizontal Frame, 470.
49) Weld the Tool Holder Top Bracket, 650, to the Tool Holder top Horizontal Frame, 630.
50) Weld the Hose/Drop Cord Holder, 500, to the Tool Holder Top Bracket, 650.
51) Attach the Eye Bolt, 510, to the Tool Holder Rear Vertical Frame, 640, and the Tool Holder Vertical Frame, 480 by threading.
52) Weld the Weed Eater Holder Rear Bracket, 520, to the Tool Holder Rear Vertical Frame, 640.
53) Weld the Weed Eater Holder Front Bracket, 530, to the Tool Holder Vertical Frame, 480.

The preferred method of using this embodiment of the invention is comprised of the following steps.
1) To connect the trailer assembly, 820, to an ATV, align the trailer assembly, 820, directly behind ATV with the tongue assembly, 810, lowered toward the ground.
   a) Continue rolling the trailer assembly, 820, toward the ATV until the top portion of the mud flaps, 330, go underneath the fender extensions on the ATV.
   b) Raise the trailer assembly, 820, up and align the front part of the tongue assembly, 810, with the tongue receiver of the ATV and slide the tongue assembly, 810, inside the tongue receiver of the ATV until the ⅝″ hole on the tongue receiver of the ATV and the tongue assembly, 810, align, then insert the ⅝″ receiver pin, 750, and insert the Retaining Clip, 760.
2) To telescope out the tongue assembly, 810, pull out the ⅝″ spring locking pin, 260, and pull the trailer assembly, 820, rearward until it stops, then release the spring locking pin, 260, locking the tongue assembly, 810, in place.
3) To telescope in the tongue assembly, 810, pull out the ⅝″ pin spring locking pin, 260, slide the trailer assembly forward and then release spring locking pin, 260.
4) To raise trailer assembly into an upright position, such as, but not limited to, when not in use, pull out the spring locking pin, 260, raise the trailer assembly, 820, up to approximately a 90 degrees vertical position and release the spring locking pin, 260, thus locking the trailer assembly in an upright position.
5) To lower the trailer assembly, 820, to the ground, pull out the ⅝″ spring locking pin, 260, lower the trailer assembly, 820, to the ground and release the spring locking pin, 260.
6) To use the fertilizer/seed spreader:
   a) Align spreader behind the rear of the trailer assembly
   b) Connect the tongue of the spreader to the rear trailer hitch, 170, with the Rear Hitch Pin, 770, and Rear Hitch Pin, 780, through the Rear Trailer Hitch Pin Hole, 680.
   c) To connect the spreader lever assembly, 830, to the trailer assembly, 820, and spreader:
      i) Hold the spreader lever assembly, 830, horizontal with the spreader and the trailer assembly, 820.
      ii) Take the vertical hose and lever bracket with the hose holder facing forward,
      iii) Insert handle into eye bolt of hose holder,
      iv) Run eye bolt through handle of main lever
      v) Insert into the spreader lever/chemical hose holder, 440, mounted on the lever with the 1/16″×¼″×¼″ rectangle tubing, slide over the lever on the spreader in the off position—the short end of the lever will be angled toward the back.
      vi) Tighten the Thumb Screw, 420.
7) To use the chemical sprayer:
   a) Remove the spreader, if installed.
   b) Remove clip, 780, and ½″ pin, 770, and pull spreader aside.
   c) Remove main lever assembly, 380, from the chemical sprayer holder.
   d) Then re-insert chemical hose holder and tighten with ¼″ thumb screw, with the hose holder, 460, being on the left side.
   e) Put the chemical spray container inside the trailer assembly, 820.
   f) Connect the wiring connector to ATV.
   g) Take hose run on left side and wrap hose around to front and right side of the Hose Holder, 460.
   h) Insert 440 into the Chemical Hose Holder Bracket, 120.
   i) Pull hose around front allowing hose to rest in Hose Holder Bracket, 460.
8) To remove the hose and chemical sprayer, just reverse this procedure.
9) To install the tool tote:
   a) Face the right side of the tool holder assembly, 840, and the right side of the trailer assembly, 820.
   b) Lift up the tool holder assembly, 840
   c) Place ¼″×1″×4″ Flat Bar Mounting Guide, 540, on inside of Right Side Top Rail, 030.
   d) Place ¼″×1″×5″ Flat Bar Mounting Plate, 550, on outside of the Right Side Top Rail, 030, of the Trailer Assembly, 820.
   e) Slide the tool holder assembly, 840, over the top rail, 030, aligning the ⅜″ holes of the ¼″×1″×5″ Flat Bar Mounting Plate, 550, with the ⅜″ nuts, 180, welded in the right side of the bottom frame, 010.
   f) Insert ⅜″×1½″ Wing Nuts With Plastic Handles, 190, and tighten securely.
   g) (An alternate securing system is to take ¼″×2″ Cotterless Hitch, 200, place in the Right Side Cotterless Hitch Hold, 730, on outside mounting plate, 550, pushing under top rail, 030, and through the Inside Cotterless Hitch Hole, 740, on the inside guide plate, 540.)
10) To remove tool holder assembly, 840, from trailer assembly, 820, just reverse this procedure.

To use the invention to load a deer:
1) With cart in upright position, release the ⅝″ spring lock pin, 260.
2) Lower the back bottom of the cart to the ground.
3) Pull cart back in order to telescope out and release the spring lock pin, 260.
4) Pull ATV past the deer, stopping cart directly in front of the deer.
5) Grab deer by the antlers or front legs and pull deer until it rests inside the cart.
6) If desired, tie deer head to ATV cart to keep the deer head from dragging the ground.

Another preferred embodiment of the invention utilizes a fixed wheel assembly and an integrated ball joint in the tongue assembly. The advantage of a cart with stationary wheels plus the tongue assembly with ball hitch is that this allows the cart to pivot—allowing the user to go over irregular terrain with the ATV with the cart keeping roughly equal pressure on both tires. An additional advantage of this embodiment of the cart is that the cart also tracks inside the tracks of the ATV—thus going anywhere the ATV goes and not staying outside the ATV tracks and hitting an obstacle, such as a rock or tree. This embodiment is made as follows:
1) Weld the Bottom Front Frame, 020, to the Bottom Frame, 010.
2) Weld the Front Top Rail, 040, to the Top Rail, 030.
3) Weld the Post, 050, to the welded combination of the Top Rail, 030, and the Front Top Rail, 040.
4) Weld the Post, 050, to the welded combination of the Bottom Frame, 010, to the Bottom Front Frame, 020.
5) Weld the Flooring with the Four Side Inserts, 060, to the welded combination of the Top Rail, 030, the Front Top Rail, 040 and welded combination of the Bottom Frame, 010 and the Bottom Front Frame 020.
6) Weld the Cross Members, 070, to welded combination of the Bottom Frame, 010, and the Bottom Front Frame, 020.
7) Weld the Front Frame Spacer, 110, to the Bottom Front Frame, 020.
8) Weld the Right Tongue Bracket, 090, to the Front Top Rail, 040, and the Right Front Frame Spacer, 110A.
9) Weld the Left Tongue Bracket, 080, to the Front Top Rail, 040, and the Left Front Frame Spacer, 110B.
10) Weld the Fertilizer Spreader Lever/Chemical Hose Holder Bracket, 120, to the Left Tongue Bracket, 080.
11) Weld the Thumb Screw Nut, 130, to the Fertilizer Spreader Lever/Chemical Hose Holder Bracket, 120.
12) Attach the Thumb Screw, 140, to the Thumb Screw Nut, 130, by threading.
13) Weld the Wheel Mounting Bracket, 160, to the Cross Members, 070, and the Bottom Frame, 010.
14) Attach the Wheel Assembly, 150, to the Wheel Mounting Bracket, 160, using the Bolt, 610, and the Lock Nut, 620 by threading.
15) Weld the Rear Trailer Hitch, 170, to the Bottom Frame, 010.
16) Slide the Front Internal Tongue 860, inside the External Tongue, 850, and keep in place by the Pin, 940, and weld.
17) The Pin, 940, travels in the Slot, 930.
18) Slide the Rear Internal Tongue, 870, inside the Collar, 880, and weld.
19) Install the Rear Internal Tongue, 870, and the Collar, 880, into the Left Tongue Bracket, 080, and the Right Tongue Bracket, 090, using the Bolt, 1090, the Lock Washer, 1110, and the Nut, 1100.
20) Weld the Right Spring Lock Bracket Spacer, 890, to the External Tongue, 850.
21) Weld the Right Spring Lock Mounting Plate, 900, to the Right Spring Lock Bracket Spacer, 890.
22) Weld the Right Spring Locking Pin, 910, to the Right Spring Lock Mounting Plate, 900.
23) Weld the Mud Flap Bracket 920 to the External Tongue, 850.
24) Attach the Mud Flap Frame, 280, to the Mud Flap Bracket, 920, using the Bolt, 590, and Lock Nut, 600, by threading.
25) Weld the Mud Flap Bracket, 270 to the External Tongue, 210.
26) Attach the Mud Flap Frame, 280, to the Mud Flap Bracket, 270 using the Bolt, 590, and the Lock Nut, 600 by threading.
27) Weld the Set Screw Holder, 340, to the Mud Flap Frame, 280.
28) Attach the Set Screw, 350, to the Set Screw Holder, 340, by threading.
29) Attach the Mud Flap Adjusting Rod, 290, to the Mud Flap Frame, 280 using the Set Screw, 350.
30) Weld the Vertical Mud Flap Brace, 320 to the Mud Flap Adjusting Rod, 290.
31) Weld the Mud Flap Guide, 300, to the Vertical Mud Flap Brace, 320.
32) Weld the Mud Flap Top Mounting Bracket, 310, to the Vertical Mud Flap Brace, 320.
33) Attach the Mud Flap, 330, to the Mud Flap Top Mounting Bracket, 310, using the Mud Flap Retaining Bolt, 790, and the Mud Flap Retaining Nut, 800.
34) Weld Plate for Left Spring Locking Pin, 980, to Left Tongue Bracket, 080.
35) Weld the Left Spring Locking Pin, 970, to Left Spring Locking Pin Plate, 980.
36) Weld the Hitch, 1010, to Height Adjustable Post 1020.
37) Weld the Height Adjustable Post, 1020, to the External Tongue, 850.
38) Weld the Hitch Ball, 1030, to the Front Internal Tongue.
39) Weld the Hitch Ball Coupling, 1040, to the Rear Internal Tongue, 870.
40) Insert the Hitch Ball Coupling Pin, 1050 into the Hitch Ball Coupling, 1040.
41)Attach the wheel mounting plate and axle assembly, 1130, using the Bolt, 610, and lock nut, 620.
42) Attach the Tire and Wheel, 1120, to the Wheel Mounting Plate and Axle Assembly, 1130, with the Cotter Pin, 1140.

The preferred method of using this embodiment of the invention is comprised of the following steps.
1) With the cart in the upright position, pull on the right spring locking pin, 910, on the right side of the tongue assembly,
2) Lower the cart to the ground,
3) Telescope out about 2 inches releasing the left spring lock pin, 970, on the left side locking the cart and the rear internal tongue into a stationary position,
4) Telescope cart the rest of the way out by releasing the right spring lock pin, 910, on the right side of the tongue assembly, locking it in the telescoped out position.
5) To raise the cart up simply reverse the procedure,
6) Now the cart is able to work off the ball hitch, 1030, allowing the cart to pivot over uneven terrain.

Part for some of the various embodiments of the invention are as follows:

| PART | | PREFERRED |
|---|---|---|
| NUMBER | PART NAME | SPECIFICATIONS |
| 010 | Bottom Frame | ⅛″ × 1″ × 1″ Square |
| | | Tubing/w 2 90° Bends |
| 020 | Bottom Front Frame | ⅛″ × 1″ × 1″ Square |
| | | Tubing |
| 030 | Top Rail | ⅛″ × 1″ × 1″ |
| | | Square Tubing/w 2 90° |
| | | Bends |
| 040 | Front Top Rail | ⅛″ × 1″ × 1″ Square |
| | | Tubing |
| 050 | Post | 1/16″ × ¾″ × ¾″ Square |
| | | Tubing |
| 060 | Flooring/w 4 Side Inserts | 20 Gauge ½″ Expanded |
| | | Metal/w Break all 4 Sides |
| 070 | Cross Members | ⅛″ × 1″ × 1″ Square |
| | | Tubing |
| 080 | Left Tongue Bracket | ¼″ × 2½″ × 2½″ Angle |
| 090 | Right Tongue Bracket | ¼″ × 2½″ × 2½″ Angle |
| 110A | Right Front Frame Spacer | ¼″ × 1″ × 2½″ Flat Bar |
| 110B | Left Front Frame Spacer | ¼″ × 1″ × 2½″ Flat Bar |
| 120 | Fertilizer Spreader | 1/16″ × ¾″ × ¾″ Square |
| | Lever/Chemical Hose | Tubing |
| | Holder Bracket | |
| 130 | Thumb Screw Nut | 5/16″ Nut |
| 140 | Thumb Screw | 5/16″ × ¾″ |
| 150 | Wheel Assembly | Wheel Assembly 10″ |
| | | Pneumatic Swivel Caster |
| | | Wheels 4.10/3.50-4 Max. |
| | | 500 lb. |
| 160 | Wheel Mounting Bracket | ⅛″ × 1″ × 1″ |
| 170 | Rear Trailer Hitch | ¼″ × 1¾″ × 2″ Flat Bar/w |
| | | ⅝″ Hole |
| 180 | Tool Holder Mounting Nut | ⅜″ Nut |
| 190 | Wing Nut | ⅜″ × 1½″ (Plastic Handle) |
| 200 | Cotterless Hitch | ¼″ × 2″ |
| 210 | External Tongue | ¼″ × 2″ × 2″ Square Tubing |
| 220 | Internal Tongue | ¼″ × 1½″ × 1½″ Square |
| | | Tubing |
| 230 | Collar | ¼″ × 2″ × 2″ Square Tubing |
| 240 | Spring Lock Bracket Spacer | ¼″ × 1½″ Flat Bar |
| 250 | Spring Lock Mounting | ¼″ × 1½″ Flat Bar |
| | Plate | |
| 260 | Spring Locking Pin | ⅝″ |
| 270 | Mud Flap Bracket | 1/16″ × ¾″ × ¾″ Angle |
| 280 | Mud Flap Frame | 1/16″ × ¾″ × ¾″ Square |
| | | Tubing |
| 290 | Mud Flap Adjusting Rod | ½″ Square Stock |
| 300 | Mud Flap Guide | ¼″ Round Stock |
| 310 | Mud Flap Top Mounting | 1/16″ × ½″ Flat Bar |
| | Bracket | |
| 320 | Vertical Mud Flap Brace | ½″ Square Stock |
| 330 | Mud Flap | 3/16″ Flexible Plastic |
| 340 | Set Screw Holder | ¼″ Nut |
| 350 | Set Screw | ¼″ × ½″ Bolt |
| 360 | Slot | ¼″ × ⅜″ × 9⅝″ |
| 370 | Pin | ⅜″ × 1⅝″ |
| 380 | Horizontal Fertilizer | 5/16″ Round Stock |
| | Spreader Lever | |
| 390 | Vertical Fertilizer Spreader | 5/16″ Round Stock |
| | Lever | |
| 400 | Fertilizer Spreader Handle | 1/16″ × ¼″ × 1¼″ |
| | Connector | Rectangle Tubing |
| 410 | Set Screw Holder | ¼″ Nut |
| 420 | Thumb Screw | ¼″ × ¾″ |
| 430 | Eye Bolt | 5/16″ × ½″ |
| 440 | Fertilizer Spreader | 5/16″ Round Stock, 25″ |
| | Lever/Chemical Hose | long |
| | Holder | |
| 450 | Fertilizer Spreader | 1/16″ × ½″ × ½″ Square |
| | Lever/Chemical Hose Insert | Tubing |
| 460 | Hose Holder | 5/16″ Round Stock |
| 470 | Tool Holder Horizontal | ⅛″ × 1″ × 1″ Square |
| | Frame | Tubing |
| 480 | Tool Holder Vertical Frame | ⅛″ × 1″ × 1″ Square |
| | | Tubing |
| 490 | Tool Holder Bracket - | ¼″ × 2½″ Flat Bar |
| | Bottom | |
| 500 | Hose/Drop Cord Holder | 5/16″ Round Stock |
| 510 | Eye Bolt | ¼″ × 1½″ |
| 520 | Weed Eater Holder - Rear | 5/16″ Round Stock |
| | Bracket | |
| 530 | Weed Eater Holder - Front | 5/16″ Round Stock |
| | Bracket | |
| 540 | Inside Mounting Guide For | ¼″ × 1″ × 4″ Flat Bar |
| | Tool Tote | |
| 550 | Outside Mounting Plate For | ¼″ × 1″ × 5″ Flat Bar |
| | Tool Tote | |
| 560 | Bolt | ½″ × 3½″ |
| 570 | Nut | ½″ |
| 580 | Lock Washer | ½″ |
| 590 | Bolt | ¼″ × 1″ |
| 600 | Lock Nut | ¼″ |
| 610 | Bolt | ⅜″ × 1½″ |
| 620 | Lock Nut | ⅜″ |
| 630 | Tool Holder Top Horizontal | ⅛″ × 1″ × 1″ Square |
| | Frame | Tubing |
| 640 | Tool Holder Rear Vertical | ⅛″ × 1″ × 1″ Square |
| | Frame | Tubing |
| 650 | Tool Holder Bracket - Top | ¼″ × 2½″ Flat Bar |
| 660 | Locking Pin Hole | ⅝″ Hole |
| 670 | Tongue Mounting Hole | ½″ Hole |
| 680 | Rear Trailer Hitch Pin Hole | ⅝″ Hole |
| 690 | Yard Tool Holder Hole | 2″ Hole |
| 700 | Bottom Tool Holder Hole | ⅜″ Hole |
| 710 | Thumb Screw Hole | 5/16″ Hole |
| 720 | Hole For Receiver Pin | ⅝″ Hole |
| 730 | Right Side Cotterless Hitch | ¼″ Hole |
| | Hole | |
| 740 | Inside Cotterless Hitch Hole | ¼″ Hole |
| 750 | Receiver Pin | ⅝″ Hole |
| 760 | Retaining Clip For Receiver | ⅛″ |
| 770 | Trailer Hitch Pin | ½″ |
| 780 | Trailer Hitch Retaining Clip | ⅛″ |
| 790 | Mud Flap Bolt | ¼″ × ¾″ Bolt |
| 800 | Mud Flap Nut | ¼″ Nut |
| 810 | Tongue Assembly | |
| 820 | Trailer Assembly | |
| 830 | Spreader Lever Assembly | |
| 840 | Tool Holder Assembly | |
| 850 | External Tongue | 2½″ × 2½″ × ¼″ Square |
| | | Tubing |
| 860 | Front Internal Tongue | 2″ × 2″ × ¼″ Square Tubing |
| 870 | Rear Internal Tongue | 2″ × 2″ × ¼″ Square Tubing |
| 880 | Collar | 2″ × 2″ × ¼″ Square Tubing |
| 890 | Spring Lock Bracket Spacer | ¼″ × 1½″ Flat Bar |
| 900 | Right Lock Mounting Plate | ¼″ × 1½″ × 2½″ |
| 910 | Right Spring Locking Pin | ⅝″ |
| 920 | Mud Flap Bracket | 1/12″ × ¾″ × ¾″ Angle |
| 930 | Slot | ¼″ × ⅜″ × 9⅝″ |
| 940 | Pin | ⅜″ × 1⅞″ |
| 950 | Hole For Right Locking Pin | ⅝″ |
| 960 | Hole For Left Locking Pin | ⅝″ |
| 970 | Left Spring Locking Pin | ⅝″ |
| 980 | Plate For Left Spring | ¼″ × 1½″ × 2″ |
| | Locking Pin | |
| 990 | Tongue Mounting Hole | ½″ |
| 1000 | Hole For Receiver Pin | ⅝″ |
| 1010 | Hitch | ¼″ × 2″ × 2″ |
| 1020 | Height Adjusting Post | ¼″ × 2″ × 2″ |
| 1030 | Hitch Ball | 1⅛″ |
| 1040 | Hitch Ball Coupling | 1⅛″ I.O. |
| 1050 | Hitch Ball Coupling Pin | ⅛″ |
| 1060 | Receiver Pin | ⅝″ |
| 1070 | Retaining Clip For Receiver | ⅛″ |
| 1080 | Tongue Assembly | |
| 1090 | Bolt | ½″ × 4½″ |
| 1100 | Nut | ½″ |
| 1110 | Lock Washer | ½″ |
| 1120 | Tire & Wheel | Wheel Assembly Stationary |
| | | Tires 15 × 6.00-6 365 lbs. |
| 1130 | Wheel Mounting Plate & | |
| | Axle Assembly | |
| 1140 | Cotter Pin | ⅛″ |

What is claimed is:

1) An ATV utility trailer comprising:
a) a frame portion having a forward end, a rearward end, opposite sides, an upper end, flooring, and a lower end, wherein said lower end is offset from said upper end;
b) a first wheel assembly and a second wheel assembly, securely attached to the bottom of said first frame portion, wherein the first wheel assembly and the second wheel assembly are non-pivoting; and
c) a slidably adjustable, elongated tongue member, having ATV securing means, wherein said tongue member utilizes a hitch ball joint assembly that allows the cart to place roughly equal pressure on the tires while going over uneven terrain.

2) The ATV utility trailer of claim 1, further comprising an adjustable mud flap assembly.

3) A selectively foldable ATV utility trailer comprising:
a) a frame portion having a forward end, a rearward end, opposite sides, an upper end, flooring, and a lower end, wherein said lower end is offset from said upper end;
b) a first wheel assembly and a second wheel assembly, securely attached to the bottom of said first frame portion, wherein said first wheel assembly and said second wheel assembly have horizontal pivotal means;
c) a slidably adjustable, elongated tongue member, having ATV securing means, wherein said tongue member has pivotal securing means about a vertical axis transverse to the longitudinal axis of said tongue member wherein said frame portion is selectively in ground-engagement to a substantially vertically disposed position rearwardly of the ATV; and
d) a rear trailer hitch attaching means.

4) The selectively foldable ATV utility trailer of claim 1, further comprising an adjustable mud flap assembly.

5) The selectively foldable ATV utility trailer of claim 2, further comprising a releasably attached tool holder assembly.

6) The selectively foldable ATV utility trailer of claim 2, further comprising a releasably attached spreader assembly.
